(19) United States
(12) Patent Application Publication
(10) Pub. No.: US 2025/0348854 A1
(43) Pub. Date: Nov. 13, 2025

(54) Real-Time NIL Payments to Student Athletes During Collegiate Athletic Events

(71) Applicant: William C. Busch, Lincoln, NE (US)

(72) Inventor: William C. Busch, Lincoln, NE (US)

(21) Appl. No.: 19/278,278

(22) Filed: Jul. 23, 2025

Related U.S. Application Data
(63) Continuation-in-part of application No. 18/977,244, filed on Dec. 11, 2024, now abandoned.
(60) Provisional application No. 63/608,708, filed on Dec. 11, 2023.

(51) Int. Cl. G06Q 20/08; G06Q 20/04; G06Q 20/32; G06Q 20/40

(52) U.S. Cl. CPC G06Q 20/085; G06Q 20/04; G06Q 20/325; G06Q 20/405

(57) ABSTRACT

A real-time NIL payment system that allows fans to make NIL payments during a game or other collegiate sporting event which are directed to a particular student athlete participating in the game or other collegiate sporting event.

### CROSS-REFERENCE TO RELATED APPLICATIONS

The present application claims priority from, and hereby incorporates by reference in their entirety, U.S. provisional patent application 63/608,708 filed Dec. 11, 2023 and U.S. utility patent application Ser. No. 18/977,244 filed Dec. 11, 2024.

### BACKGROUND

### Field of the Invention

Various embodiments of the present invention relate to apparatus and methods for making payments to participants in an event, and in particular, to making name, image and likeness (NIL) payments to college athletes during a collegiate athletic event.

### Description of Related Art

In 2019 California, Alabama, Georgia, Florida and a number of other states began passing laws allowing college athletes to be paid for use of their name, image and likeness (NIL). The leadership of the National Collegiate Athletic Association (NCAA) initially agreed to implement rules defining a system for NIL payments to collegiate athletes by January 2021. The NCAA later backed off its effort to implement NIL payments, citing antitrust concerns.

The U.S. Supreme Court case Alston vs. NCAA, unanimously decided on Jun. 21, 2021, prohibited the NCAA from limiting education-related benefits to athletes. Meanwhile, more and more states passed laws allowing for NIL payments to college athletes. Most of the state NIL laws were set to become effective just prior to the 2021 season. Finally, on Jun. 30, 2021, just prior to many of the state NIL laws taking effect, the NCAA announced an interim NIL policy that allowed NCAA athletes to be paid for their name, image and likeness.

Today, nearly all large collegiate athletic programs have systems in place to make regularly scheduled NIL payments to their athletes. Many thousands of college athletes now receive monetary payments from NIL programs aligned with their school or have signed commercial endorsement deals which provide for NIL payments. The NIL payments made as part of these conventional NIL programs are regularly scheduled and negotiated with the student athlete ahead of time.

### BRIEF SUMMARY

The present inventor recognized a need for fans to be able to contribute towards NIL payments that would go directly to a particular athlete during a live collegiate athletic event, for example, during a game or other event relating to athletics. The various embodiments achieve this objective, and others, as discussed in the paragraphs below and illustrated in the drawings.

Various embodiments of the present disclosure provide method of collecting and distributing a real-time NIL payment during a collegiate athletic event. The method involves setting up a real-time NIL payment system and creating player NIL accounts in the real-time NIL payment system. Each of the player NIL accounts is associated with a given one of the student athletes who may be receiving an NIL payment.

In accordance with various embodiments a player NIL ID is assigned to each student athlete enrolled at the university. The player NIL IDs identify the various student athletes for purposes of making NIL payments using the real-time NIL payment system. Typically, an NIL prompt is displayed during a collegiate athletic event, prompting a real-time NIL payment from one or more fans. The player NIL ID associated with the real-time NIL payment designates the student athlete who will be the recipient. The real-time NIL payment is deposited in a player NIL account associated with the designated student athlete.

### DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 is a flowchart of a method of practicing various embodiments.

FIG. 2A depicts an example of an athlete likeness with a player NIL identity, according to various embodiments.

FIG. 2B depicts a stadium scoreboard showing game replay footage on the stadium replay screen with a player NIL ID being displayed, according to various embodiments.

### DETAILED DESCRIPTION

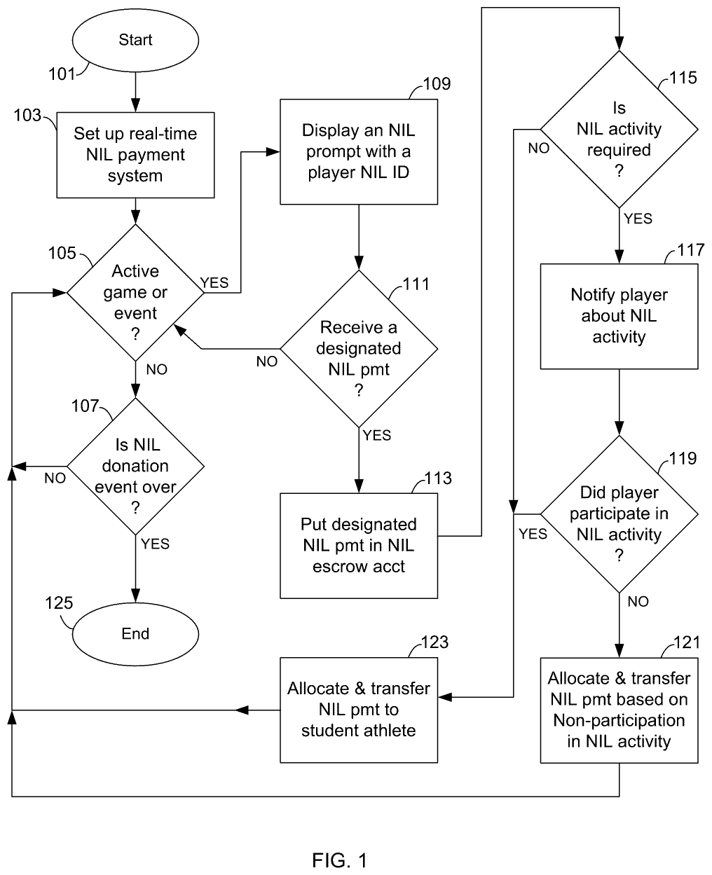

FIG. 1 is a flowchart of a method of practicing various embodiments of the invention. The method begins at block 101 and proceeds to block 103 where a real-time NIL payment program is set up for student athletes eligible to receive NIL payments who are enrolled at a university or college. The real-time NIL payment system may be installed and operated by the university, or in some instanced, may be installed and operated by a third-party such as an NIL collective. Typically, the university provides NIL counseling and education to student athletes, and may also provide information to the public regarding where NIL donations can be directed. However, the universities (subject to current rules) do not enter into contracts with student athletes, and typically do not accept NIL donations or handle the monetary transactions. NIL collectives often handle the collection, administration and dispersion of NIL money. An NIL collective is typically affiliated with a given university, but not officially part of the university. The NIL collective may enter into contracts with student athletes and may handle monetary transaction that are eventually directed to student athletes as NIL payments. For example, The 1890 Initiative and The Big Red Collaborative are two NIL collectives associated with the University of Nebraska athletics.

Returning to block 103 of the method, setting up the real-time NIL payment system involves a number of activities. Some of the setup activities are performed by the NIL collective, some are performed by the university, and some may be performed through cooperation between the university and the NIL collective. The real-time NIL payment system setup activities may include the following:
Finding out account information for making NIL payments to an NIL collective for given student athletes participating in the real-time NIL payment system.
Setting up player NIL IDs (NIL Identities) for various student athletes in order to facilitate NIL donations intended for designated student athletes.
Providing information for setting up fan accounts for fans who plan to attend or watch a live collegiate athletic event and may want to make a real-time NIL payment. The fan accounts help the NIL collective (and perhaps the university) keep track of how much each fan or fan organization has donated.
Providing information for setting up one or more real-time electronic payment methods for fans to use, e.g., Venmo, Google Pay, Apple Pay, Cash App, Zelle, ACH cash transfer, or other like types of digital payment.
Coordinating with the announcers, the staff controlling the replay devices—e.g., big screen for game replays, and radio and television station broadcasters.
Defining and arranging NIL activities—e.g., public appearances, post-game media interviews, public service events.
Ensuring compliance with NCAA regulations and any state or federal laws that may apply.

Once the real-time NIL payment system is set up the method proceeds from block 103 to block 105 to determine whether a game or NIL donation event is currently active. The game could be a game of football, volleyball, basketball, baseball, wrestling, track and field, lacrosse, bowling, or any of dozens of sports played by collegiate athletes eligible to receive NIL payments. An NIL donation event could be any of the types of games described above, or could be another type of event involving college athletes such as a spring game, an open practice, a meet-the-player day, a booster event or awards ceremony. For the sake of brevity, the various embodiments will be described in terms of a game being played.

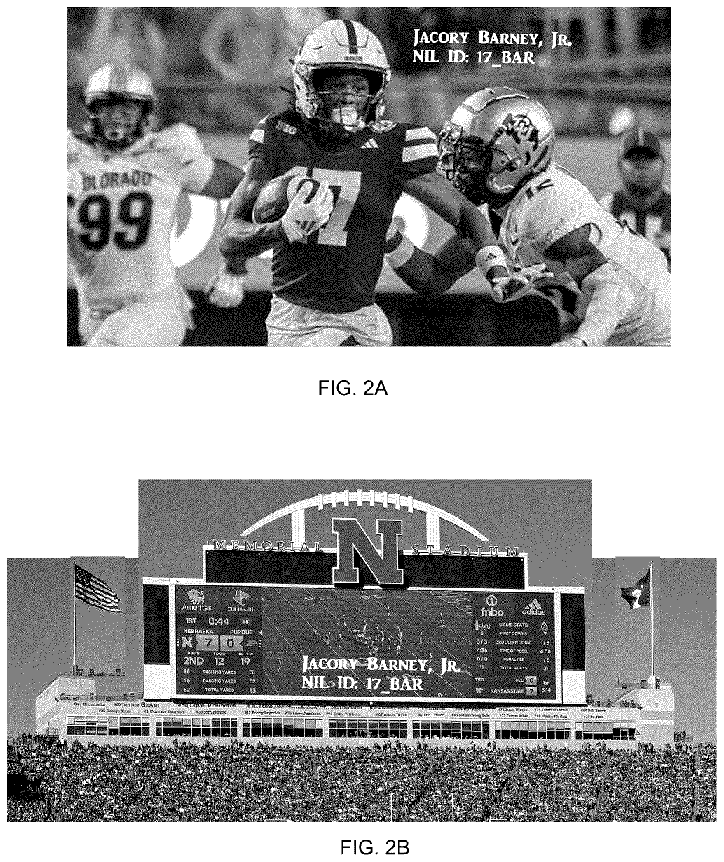

If the game is currently being played the method proceeds to block 109 along the YES path. In block 109 the real-time NIL payment system displays an NIL prompt with a player NIL ID. For example, the NIL prompt may be a player likeness as shown in FIG. 2A or a video replay as shown in FIG. 2B on the replay big screen in the stadium or arena. Most stadiums and arenas have one or more large video screen for playing replays, which for the purposes of this disclosure, shall be called a “replay big screen.” The player NIL ID may take any of a number of formats-so long as the player NIL ID is unique for a particular player. The player NIL ID shown in FIGS. 2-3 is the player's jersey number in combination with the first three letters of his last name: “17_BAR”. In some embodiments the NIL prompt with a player NIL ID may be displayed on a television during a live broadcast of the game or other NIL donation event. In some embodiments the NIL prompt with a player NIL ID may be displayed on a website—e.g., a website providing a live feed audio broadcast of the game. In some embodiments, a player NIL ID may be provided for a group of players in addition to player NIL IDs for each individual player. For example, a player NIL ID could be provided for the starters on the offensive line, for the kickoff team, for the defensive backfield, for the walk-ons, for the senior players, or for any other group of players likely to attract an NIL payment.

Typically, any information required to make an NIL donation is provided ahead of time on the big screen and/or is provided in the programs. Such information may be posted on signs throughout the stadium or in the arena, may be available on a website, may be available via text message, or may be reached by scanning a QR code with a mobile phone, or by other such manners of conveying information known to those of ordinary skill in the art. Such information includes instructions and account information for the real-time pay system(s) being used—e.g., Venmo, Google Pay, Apple Pay, Cash App, Zelle, ACH cash transfer, or other like types of real-time payment methods or digital payment apps known to those of ordinary skill in the art. The information may also include a team roster that lists the player NIL IDs. Block 109 may involve displaying an NIL prompt with multiple player NIL IDs.

Once the NIL prompt with a player NIL ID has been displayed in block 109 the method proceeds to block 111 to determine whether a designated NIL payment has been received. The NIL payment may come from a fan or group of fans, a fan organization such as a booster group, a business or any other entity authorized to make an NIL payment. Under present rules universities cannot directly pay student athletes, and would therefore be ineligible to make an NIL payment. A designated NIL payment is an NIL donation that designates one or more student athletes as recipients—e.g., identifies the student athlete(s) using his/their player NIL ID(s). If no NIL payment was received in block 111 the method proceeds along the NO path back to block 105 to cycle through the method again and determine whether or not the game is still active. However, if it is determined in block 111 that a designated NIL payment was received the method proceeds along the YES path to block 113.

Upon receiving a designated NIL payment in block 113 the funds are deposited in an escrow-type account until the student athlete has fulfilled the NIL activity—if any is required—associated with the payment. The escrow-type account is typically owned and controlled by an NIL collective—not by the university or the student athlete. Once the NIL payment has been deposited in an escrow-type account the method proceeds to block 115 to determine whether an NIL activity is required to consummate the transaction. The rules of NIL are not completely settled yet, and various state laws may be in effect that mandate NIL payments only for certain types of activities, and may prohibit NIL payments for game performances. Therefore, the various embodiments allow for the performance of an NIL activity by the student athlete to consummate the transaction of the NIL payment to the student athlete. Depending upon how the real-time NIL payment system is set up, the system may allow the payor of the NIL payment to specify the type of NIL activity—if one is required.

The NIL activity may be performed in various manners. For example, the NIL activity may entail giving a post-game media interview. In some instances the student athlete may not be available for a post-game interview—e.g., due to injury or another prior commitment. In such instances the NIL activity may be fulfilled by another activity mutually agreed upon by both parties—e.g., a public appearance or appearance at a booster event, a public service event such as visiting a local hospital, a radio or TV interview, a commercial publicity event such as a meet-and-greet at a local business, a dinner or other meal with the NIL payor or others of his choosing, or other like types of NIL activities that are known to those of ordinary skill in the art.

If it is determined in block 115 that no NIL activity is required, the method proceeds along the NO path to block 123 to allocate and transfer the NIL payment. However, if it is determined in block 115 that an NIL activity will be required, the method proceeds from block 115 to block 117. In block 117 the student athlete is notified about the NIL activity and given the option of performing the activity to consummate the transaction or declining the offer of the NIL payment.

The method proceeds to block 119 where it is determined whether the student athlete completed the NIL activity. In some implementations the player need merely agree to the NIL activity in order to have the NIL payment allocated to him (or her), and performance of the NIL activity can come later. In the present disclosure, however, we assume that the student athlete must perform the NIL activity before being paid. If it is determined that the student athlete did participate in the NIL activity the method proceeds to block 123 to allocate all or part of the NIL payment to the student athlete. In some implementations a portion of the NIL payment may be allocated to overhead costs or transaction costs, as agreed upon in advance by the student athlete (and sometimes by the NIL payor as well). In some instances the NIL payor may designate the NIL payment being split among two or more student athletes in predefined amounts (specified by the NIL payor). In block 123 the NIL payment is split accordingly. Upon allocating and transferring the NIL payment in block 123 the method proceeds to block 105 to again determine whether the game is still active, and cycles through the method again.

Back in block 119 if it is determined that the student athlete did not participate in the NIL activity (and does not plan on doing so) the method proceeds along the NO path to block 121 to handle to NIL allocation and payment, depending upon the preferences of the NIL payor. It is sometimes the case that the funds will simply be refunded to the NIL payor. In other instances the NIL payor may specify one or more other student athletes to receive the NIL payment. In some instances the NIL payor may specify that the NIL payment be used to cover the costs and overhead of the NIL collective. Upon allocating and transferring the NIL payment in block 121 the method proceeds to block 105 to again.

If it is determined in block 105 that the game is no longer active the method proceeds to block 107 to determine whether the NIL donation event is over. The NIL donation event typically lasts longer than the game. The NIL prompt with various player NIL IDs may be displayed before the game starts as fans are taking their seats. The NIL prompt with various player NIL IDs may be displayed after the game ends as fans are making their way out of the stadium. Post-game NIL prompts may be displayed in conjunction with game highlights and replays of big plays. Once it is determined in block 107 that the NIL donation event is over the method proceeds to block 125 and ends.

In regard to the method flow chart depicted in FIG. 1 and disclosed in the paragraphs above, it should be noted that some of the activities may be performed in conjunction with each other, or in a different order than shown in FIG. 1. For example, some of the tasks of setting up the real-time NIL payment system shown in block 103 may take place months or even years before the game or other athletic event (e.g., setting up player NIL IDs), while other tasks of block 103 may be performed at gametime (e.g., providing information for setting up fan accounts for fans). The activity described in block 109 may be implemented on gameday during the game (e.g., displaying a student athlete's likeness and NIL ID on the replay big screen) or may be done in a semi-permanent manner over the course of weeks or months (e.g., displaying the student athlete's likeness and NIL ID on posters throughout the stadium, in the game program, or on a website available to fans).

Block 123 shows allocating and transferring funds to the student athlete. The funds may be allocated to the student athlete—or rather to an account associated with the student athlete but owned by an NIL collective—and then later transferred to the student athlete over time rather than transferring them in one lump sum. The first player NIL account associated with the first student athlete and the second player NIL account associated with the second student athlete may, in some implementations, be separate accounts owned, for example, by an NIL collective. In other implementations the first player NIL account and the second player NIL account may be contained in the same account that holds funds for NIL payments to a number of student athletes. In such instance the NIL collective (or whoever controls the account) keeps records of how much is owed to each student athlete with funds in the NIL account.

For the sake of clarity, the description provided in conjunction with the method of FIG. 1 discusses a fan making an NIL payment. However, the NIL payment may come from a single fan or a group of fans, a fan organization such as a booster group, a business or any other entity authorized to make an NIL payment. For the purposes of this disclosure, a “fan” making an NIL payment is any person or entity authorized to make an NIL payment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including” used in this specification specify the presence of stated features, integers, steps, operations, elements, and/or components, but do not preclude the presence or addition of one or more other features, integers, steps, operations, elements, components, and/or groups thereof. The term “plurality”, as used herein and in the claims, means two or more of a named element. It should not, however, be interpreted to necessarily refer to every instance of the named element in the entire device. Particularly, if there is a reference to “each” element of a “plurality” of elements. There may be additional elements in the entire device that are not be included in the “plurality” and are not, therefore, referred to by “each.”

The description of the various embodiments provided above is illustrative in nature inasmuch as it is not intended to limit the invention, its application, or uses. Thus, variations that do not depart from the intents or purposes of the invention are intended to be encompassed by the various embodiments of the present invention. Such variations are not to be regarded as a departure from the intended scope of the present invention.

What is claimed is:

1. A method of collecting and distributing a real-time NIL payment during a collegiate athletic event, the method comprising:
setting up a real-time NIL payment system;
creating a plurality of player NIL accounts in the real-time NIL payment system, each of the plurality of player NIL accounts being respectively associated with one of a plurality of student athletes, wherein the plurality of player NIL accounts includes a first player NIL account associated with a first student athlete among the plurality of student athletes;
assigning a first player NIL ID to the first student athlete enrolled at a university, the first player NIL ID identifies the first student athlete for purposes of the real-time NIL payment system;
displaying an NIL prompt during the collegiate athletic event;
receiving the real-time NIL payment from the first fan, wherein the real-time NIL payment designates the first student athlete as a recipient using the first player NIL ID; and
depositing the real-time NIL payment in the first player NIL account associated with the first student athlete.

2. The method of claim 1, wherein the collegiate athletic event takes place at the university, the method further comprising:
creating a plurality of fan accounts in the real-time NIL payment system, each of the plurality of fan accounts being respectively associated with one of a plurality of fans.

3. The method of claim 1, wherein the setting up of the real-time NIL payment system includes opening a payment receipt account for receiving real-time electronic payments; and
wherein the receiving of the real-time NIL payment from the first fan is prompted by the displaying of the NIL prompt.

4. The method of claim 3, wherein the payment receipt account is either a Venmo account or an Apple Pay account.

5. The method of claim 3, wherein the payment receipt account is owned by an NIL collective associated with the university.

6. The method of claim 5, wherein the first player NIL account associated with the first student athlete is owned by the NIL collective associated with the university.

7. The method of claim 1, wherein said displaying the NIL prompt further comprises:
displaying the first player NIL ID.

8. The method of claim 7, wherein the NIL prompt is displayed on a replay big screen at the collegiate athletic event.

9. The method of claim 7, wherein the NIL prompt is displayed on a television screen.

10. The method of claim 1, further comprising:
notifying the first student athlete that an NIL activity is required for the real-time NIL payment.

11. The method of claim 10, further comprising:
monitoring the first student athlete for performance of the NIL activity; and
depositing the real-time NIL payment in the first player NIL account associated with the first student athlete in response to the performance of the NIL activity.

12. The method of claim 1, wherein the real-time NIL payment from the first fan designates a first portion of the real-time NIL payment to the first student athlete and a second portion of the real-time NIL payment to a second student athlete.

13. The method of claim 12, wherein the depositing of the real-time NIL payment in the first player NIL account associated with the first student athlete deposits the first portion of the real-time NIL payment in the first player NIL account.

14. The method of claim 13, further comprising:
depositing the second portion of the real-time NIL payment in a second player NIL account associated with the second student athlete.
